(19) United States
(12) Patent Application Publication
(10) Pub. No.: US 2025/0012700 A1
(43) Pub. Date: Jan. 9, 2025

(54) APPARATUS AND METHOD FOR PENETRATION TESTING OF PROTECTIVE CLOTHING AGAINST FLUIDS

(71) Applicant: Chairman, Defence Research & Development Organisation (DRDO), New Delhi (IN)

(72) Inventors: Prabhat Garg, Madhya Pradesh (IN); Damayanti Meher, Madhya Pradesh (IN); Vikas Baburao Thakare, Madhya Pradesh (IN); Atul Kumar Sonkar, Madhya Pradesh (IN)

(21) Appl. No.: 18/713,329

(22) PCT Filed: Nov. 3, 2022
(86) PCT No.: PCT/IN2022/050969

§ 371 Date: May 24, 2024

(30) Foreign Application Priority Data
Nov. 24, 2021 (IN) 202111054266

(51) Int. Cl. G01N 15/08

(52) U.S. Cl. CPC G01N 15/0806; G01N 15/082

(57) ABSTRACT

The present invention relates to an apparatus and a method for penetration testing of protective clothing against fluids. The apparatus comprises a test specimen holding fixture to support the test specimen, and a fluid dispersing device for dispersing a stream of pre-defined amount of the test fluid to a targeted area of the test specimen, at a constant rate. The fluid dispersing device comprises a syringe having a plunger and a needle, and a syringe actuator for applying pressure to the plunger to enable ejection of the test fluid accommodated within the syringe, through the needle, to the targeted area of the test specimen.

### CROSS-REFERENCE TO RELATED APPLICATIONS

The present application is a submission under 35 U.S.C. § 371 which claims priority to International Application No. PCT/IN2022/050969, filed Nov. 3, 2022, which claims priority to Indian Application No. 202111054266, filed Nov. 24, 2021, the disclosures of which are incorporated herein by reference in their entireties.

### FIELD OF INVENTION

The present invention relates to the field of penetration testing, and more specifically relates to an apparatus and a method for penetration testing of protective clothing against fluids.

### BACKGROUND OF THE INVENTION

The subject matter discussed in the background section should not be assumed to be prior art merely because of its mention in the background section. Similarly, a problem mentioned in the background section or associated with the subject matter of the background section should not be assumed to have been previously recognized in the prior art. The subject matter in the background section merely represents different approaches, which in and of themselves may correspond to implementations of the claimed technology.

There are several situations where workers are exposed to infective micro-organisms such as biological agents, including those which have been genetically modified, which may be able to provoke infection, allergy or toxicity. In some environments, e.g. microbiological laboratories and biotechnological productions, the infective agents are usually well known. In other types of work, the agents with which workers are exposed may not be known and only possible risks can be assessed. This happens, for example, in agriculture works, waste treatments, in particular hospital wastes, veterinary laboratories, and emergency clean-ups. In all these environments, protective clothing are necessary to prevent the infective agent from reaching the skin.

Workers, primarily health care professionals, involved in treatment of patients can themselves get exposed to biological liquids capable of disease transmission. In general, such diseases, caused by variety of micro-organisms pose significant risk to life of healthcare professionals. This is true in case of body fluid borne viruses that cause hepatitis (hepatitis B virus HBV and hepatitis C virus HCV), acquired immune deficiency syndrome (AIDS), human immune deficiency virus (HIV) and severe acute respiratory syndrome coronavirus 2 (SARS-CoV-2). During a medical procedure, a blood vessel of the patient can be punctured resulting in a high-velocity stream of blood impacting to the skin or mucous membrane of healthcare professional. The impact velocity of blood stream depends on blood pressure of the patient, size and distance of the puncture. Smaller or/and closer the puncture, higher the impact of blood stream. It is always desirable to reduce the potential of direct skin contact of these viruses by using protective clothing that resists penetration.

Permeability of a material relates to the ability of fluids and fluid transmissible particles to penetrate the material. Different materials have different permeabilities according to their structural formations. Some materials are impermeable to some fluids, that is, they are unable to be penetrated by those fluids. In actual, materials are semi-permeable to various fluids.

In an effort to protect workers and healthcare professionals who are exposed to blood borne pathogens or other infectious materials at work, the Occupational Safety and Health Agency (OSHA) has set requirements for the penetrability of protective clothing by blood-borne pathogens and/or other infectious materials, i.e., Standard governing occupational exposure to blood-borne pathogens (56 FR 64004) of Dec. 6, 1991. The protective clothing can be made by reusable materials as well as by single-use materials. A great many materials and manufacturing technologies have evolved in an attempt to meet the criteria for a safe, effective and comfortable protective barrier.

Recently, there has been substantial concern over safety of healthcare professions and others who come in contact with body fluid that may contain pathogens such as SARS-CoV-2 and/or HIV, as well as other infectious materials. In some penetration tests, the permeability of various pathogens or fluid transmitted particles other than blood is tested. In these cases, alternative detection means other than visual detection are used to determine if penetration has occurred. For example, chemical detectors, or other alternative detectors are used where the fluid is colorless and cannot be visually detected. If the fluid is colorless, dyes or other coloring agents can also be added to aid in the visual detection process.

Material penetration testing is conducted with testers which use pressurized or impact fluid penetration mechanisms to demonstrate material liquid penetration resistance. These tests and testers are explained in the following test standards:
American Society for Testing and Materials (ASTM) F903-18; Standard Test Method For Resistance of Protective Clothing To Penetration By Liquids,
ASTM 1670/F1670M-17a; Standard Test Method for Resistance of Materials Used in Protective Clothing to Penetration by Synthetic Blood;
ASTM F1671/F1671M-13; Standard Test Method for Resistance of Materials Used in Protective Clothing to Penetration by Blood-Borne Pathogens Using Phi-X174 Bacteriophage Penetration as a Test System,
International Organization for Standardization (ISO) 16604:2004(en); Clothing for Protection against Contact with Blood and Body Fluids Determination of resistance of Protective Clothing Materials to Penetration by Blood-borne Pathogen-Test Method using Phi-X174 Bacteriophage, and
Indian Standard (IS) 16546:2106: Clothing for Protection Against Contact with Blood and Body Fluids, Determination of the Resistance of Protective Clothing Materials to Penetration by Blood and Body Fluids, Test Method using Synthetic Blood.

According to the above test standards, material to be tested is mounted in a test cell which in turn is attached to an air pressure line. A challenge fluid is then exposed to a test material for a predetermined period of time at a predetermined air pressure. These test methods are based on subjecting test materials to contained hydrostatic pressures which are not representative of actual use conditions experienced by wearers of protective clothing where a stream of fluid is impacted on outer surfaces of a material of the protective clothing, skin or mucous membrane of the wearer. The contained hydrostatic pressure methods unnaturally expand, stretch, and pull apart the material structure thereby causing failure of the liquid/pathogen barrier and avoidable negative results are achieved in both liquid and pathogen penetration tests. Therefore, the contained hydrostatic pressure methods are too rigorous for protective clothing and unnecessarily expensive for manufacturers and consumers.

Another examples of penetration testing of protective clothing testing include:
ASTM F1862/F1862M-17, Standard Test Method for Resistance of Medical Face Masks to Penetration by Synthetic Blood (Horizontal Projection of Fixed Volume at a Known Velocity),
ISO 22609:2004, Clothing for Protection Against Infectious Agents-Medical Face Masks-Test Method for Resistance Against Penetration by Synthetic Blood (fixed volume, horizontally projected), and
IS 16289:2014, Medical Textiles-Surgical Face Masks-Specifications.

The above test standards require an apparatus in which a specimen test material is mounted on a specimen holding fixture and a stream of pre-selected amount of blood/pathogen barrier/body fluid is impacted to the specimen test material at a pre-selected pressure. A nozzle for ejection of the stream is connected to a pressure line and a reservoir of blood/pathogen barrier/body fluid for the ejection of the stream at a desired pressure.

The apparatus used in the above test methods are typically complicated in design, cumbersome to set up, time consuming to use, difficult to clean, semi-portable, not suitable for field use, and expensive. To determine the permeability of various materials against blood or body fluids, efforts have been made in the past to find a simple test method and apparatus for penetration testing of protective clothing against fluids.

There is therefore a need in the art for simple and effective technique for penetration testing of protective clothing against fluids, without the requirement of complicated and expensive equipment.

The present invention has been envisaged in view of the above-mentioned circumstances, and it is an object thereof to provide a novel apparatus and method for penetration testing of protective clothing against fluids.

### OBJECTS OF THE INVENTION

An object of the present invention is to provide a reliable and efficient apparatus for penetration testing of protective clothing against fluids such as, blood-borne pathogens or bodily fluids, and method thereof.

Another object of the present invention is to provide a cost-effective and simple apparatus for penetration testing of protective clothing against fluids, and method thereof.

Another object of the present invention is to provide an apparatus for penetration testing of protective clothing against fluids, which include modular components that are highly portable, and method thereof.

Another object of the present invention is to provide an apparatus and method for penetration testing of protective clothing against a test fluid, capable of accurately defining range of pressures that a test specimen will withstand, before penetration, by the test fluid.

Another object of the present invention is to provide an apparatus and method for penetration testing of protective clothing against fluids, which are suitable for laboratory and field use by both technical and non-technical individuals.

Still another object of the present invention is to provide an apparatus and method for penetration testing of protective clothing against fluids, capable of efficiently simulating actual use conditions by applying non-contained hydrostatic and mechanical pressures to surface of the test specimen.

Yet another object of the present invention is to provide an apparatus and method for penetration testing of protective clothing against fluids, which cause minimal deflection, expansion, stretching, or pulling apart of the test specimen.

### SUMMARY OF THE INVENTION

In order to achieve the above-mentioned objects, according to an aspect of the present invention, an apparatus for penetration testing of a test specimen against a fluid, and method thereof is disclosed.

According to an aspect of the present invention, the apparatus includes a test specimen holding fixture to support the test specimen, and a fluid dispersing device for dispersing a stream of pre-defined amount of the test fluid to a targeted area of the test specimen at a constant rate. The fluid dispersing device includes a syringe having a plunger and a needle attached thereto, and a syringe actuator of applying pressure to the plunger to enable ejection of the test fluid accommodated within the syringe through the needle to the targeted area of the test specimen.

According to an embodiment of the present invention, the test specimen holding fixture is mounted at a pre-defined distance from the fluid dispersing device.

According to an embodiment of the present invention, the syringe actuator applies pressure to the plunger at a constant rate.

According to an embodiment of the present invention, the pre-defined amount of the test fluid ranges from 0.1 mL to 10 mL.

According to an embodiment of the present invention, the stream of pre-defined amount of the test fluid impacts the targeted area of the test specimen at a pre-defined pressure ranging from 10 mmHg to 250 mm Hg.

According to an embodiment of the present invention, the apparatus further includes a penetration detector for quantitative determination of extent of penetration of the testing fluid on the targeted area of the test specimen.

According to an embodiment of the present invention, the test specimen holding fixture includes a front wall and an outer door. The front wall has a cut-out in which a convex backing is configured to mount the test specimen. The convex backing is positioned between the front wall and the outer door.

According to an embodiment of the present invention, the convex backing has a slot to enable a user to visually determine the extent of penetration of the testing fluid on the targeted area of the test specimen.

Another aspect of the present invention relates to a method for penetration testing of the test specimen against the test fluid. The method includes mounting the test specimen on a test specimen holding fixture, applying, by the syringe actuator, pressure to the plunger of the syringe, at a constant rate, to enable ejection of the test fluid accommodated within the syringe towards the targeted area of the test specimen, and dispersing, by the syringe, a stream of pre-defined amount of the test fluid to the targeted area of the test specimen at a constant rate.

According to an embodiment of the present invention, the method includes a step of allowing the stream of pre-defined amount of the test fluid to impact the targeted area of the test specimen at a pre-defined pressure.

Other aspects and advantages of the invention will become apparent from the following description, taken in conjunction with the accompanying drawings, illustrating by way of example, the principles of the invention.

### BRIEF DESCRIPTION OF THE ACCOMPANYING DRAWINGS

FIG. 1 illustrates a schematic representation of an apparatus for penetration testing of a test specimen against a test fluid, in accordance with an embodiment of the present invention.

FIG. 2 illustrates a block diagram of a method for penetration testing of the test specimen against the test fluid, in accordance with an embodiment of the present invention.

FIGS. 3A and 3B illustrate representations of correlation graphs for determination of flow rate of the test fluid at desired ejecting pressure, in accordance with an embodiment of the present invention.

### DETAILED DESCRIPTION OF THE INVENTION

The detailed description set forth below in connection with the appended drawings is intended as a description of various embodiments of the present invention and is not intended to represent the only embodiments in which the present invention may be practiced. Each embodiment described in this disclosure is provided merely as an example or illustration of the present invention, and should not necessarily be construed as preferred or advantageous over other embodiments. The detailed description includes pre-defined details for the purpose of providing a thorough understanding of the present invention. However, it will be apparent to those skilled in the art that the present invention may be practiced without these pre-defined details.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the preferred, arrangements and methods are now described.

Exemplary embodiments will now be described more fully hereinafter with reference to the accompanying drawings, in which exemplary embodiments are shown. This disclosure may however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as pre-defined examples thereof, are intended to encompass both structural and functional equivalents thereof. Additionally, it is intended that such equivalents include both currently known equivalents as well as equivalents developed in the future (i.e., any elements developed that perform the same function, regardless of structure).

The present invention relates to an apparatus and a method for penetration testing of a test specimen pertaining to a protective clothing against a test fluid. The test fluid may be bodily fluids, blood borne pathogens, or biological micro-organisms. The apparatus and the method of the invention measure resistance of protective clothing materials, such as textile materials for medical use to the test fluid, by dispersing a stream of known amount of the test fluid at pre-defined pressure to a test specimen pertaining to the protective clothing materials, mounted at a desired distance. Thus, the present invention relates, in part, to an apparatus for ejecting a pre-selected amount of the test fluid with pre-selected pressure or velocity to the test specimen mounted at a targeted distance, and a method thereof.

The present invention obviates problems associated with conventional testing apparatus and methods, by providing an apparatus and method for dispersing a known amount of liquid stream at pre-defined pressure to a targeted specimen mounted at a desired distance. The apparatus and method of the invention enable a user to determine resistance of protective clothing materials, i.e., test specimen, such as textile materials for medical use, especially medical facemasks, personal protective ensemble (PPE), surgical gloves, medical boot covers, gowns, aprons, and the likes, against fluids such as blood, bodily fluids, pathogens containing fluid or other liquid, quickly and conveniently. When necessary, components of the apparatus may be easily detached/disconnected or replaced, to improve portability thereof. Further, by selecting appropriate components, flow rate of the fluid, and amount of the fluid may be varied for measuring penetration of the test specimen, without the use of complicated apparatus.

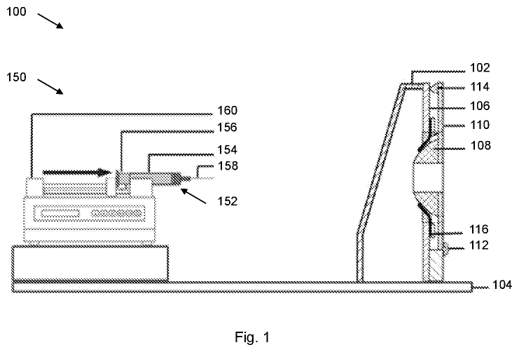

FIG. 1 illustrates a schematic representation of an apparatus (100) for penetration testing of the test specimen against a test fluid, in accordance with an embodiment of the present invention. The apparatus (100) includes a test specimen holding fixture (102) to support the test specimen. The test specimen holding fixture (102) may be made of material including transparent polymer or glass. The test specimen holding fixture (102) is mounted on a platform (104) and is in the form of an open-ended transparent box. The test specimen may be formed of a material having a composite of fabric.

The test specimen holding fixture (102) includes a front wall (106) having a cut-out adapted to fit a convex backing (108) on which the test specimen is mounted. The convex backing (108) is a solid section fixed on an outer door (110) of the test specimen holding fixture (102). The test specimen is mounted on the convex backing (108) attached to the outer door (110), which is connected to the test specimen holding fixture (102) by ring hinges (112). The outer door (110) may be closed with the test specimen in position between the front wall (106) and the outer door (110). The outer door (110) may be held closed by magnetic strips (114) along the front wall (106). The outer door (110) may be made of transparent polymer material or glass.

The convex backing (108) and the outer door (110) may contain slots through their center, to allow a user to visually determine extent of penetration of the test fluid on the test specimen. In an embodiment, the slots of the convex backing (108) and the outer door (110) may be used to determine if the test fluid has penetrated an inner surface of the test specimen. The slots of the convex backing (108) and the outer door (110) may be covered by rubber cuffs (116) secured to the front wall (106). The rubber cuffs (116) are adapted to draw the test specimen across the convex backing (108).

The apparatus (100) includes a fluid dispersing device (150) for dispersing a stream of pre-defined amount of the test fluid to a targeted area of the test specimen at a constant rate. The fluid dispersing device (150) may be placed on the platform (104) at a pre-determined distance from the test specimen holding fixture (102). The fluid dispersing device (150) includes a syringe (152) containing a body (154), a plunger (156), a needle (158) attached thereto. The body (154) of the syringe (152) accommodates a specific amount of the test fluid.

The fluid dispersing device (150) also includes a syringe actuator (160) for applying pressure to the plunger (156), at a constant rate, to allow ejection of the test fluid accommodated within the body (154) of the syringe (152), through the needle (158), to the targeted area of the test specimen mounted on the convex backing (108). To this effect, the stream of pre-defined amount of the test fluid impacts the targeted area of the test specimen at a pre-defined pressure. The needle (158) attached to the syringe (152) is aligned with center of the targeted area of the test specimen. Distance of a tip of the needle (158) may be adjusted according to the desired distance of the tip from the test specimen holding fixture (102). The syringe actuator (160) may include a pneumatic device for moving the plunger (156) in order to compress volume of body (154) of the syringe (152) at a constant speed.

The fluid dispersing device (150) is placed on the platform (104) at a pre-defined distance from the test specimen for ejecting a pre-selected amount of the test fluid in the form of stream at a constant pre-selected pressure, such that the test fluid to be ejected through the needle (158) of the syringe (152) is delivered at constant rate into atmosphere and onto the targeted area of the test specimen mounted on the convex backing (108), with a desired pressure. The test fluid to be ejected through the needle (158) of the syringe (152) may be an aqueous liquid selected from the group consisting of synthetic blood, pathogen containing liquid or bodily fluids.

In a preferred embodiment, the body (154) of the syringe (152) is marked with volumetric calibrations, such that volume of the test fluid dispensed may be easily determined through visual inspection. The plunger (156) of the syringe (152) is preferably equipped with a gas-tight seal, preferably composed of rubber or PTFE. It is further preferred that the needle (158) of the syringe (152) is easily detachable from the syringe (152) such that syringes of different sizes or containing various amounts of the test fluid may be attached and detached from the same needle. The needle (158) may attached to the syringe (152) using a Luer-Lok fitting, or other such attachment means well known to those skilled in the art. The needle (158) may be made of any metal, preferably stainless steel. Alternatively, needles made of other materials such as plastic or Polytetrafluoroethylene (PTFE) may also be used. The pressure at which the stream of the test fluid is dispersed depends upon the internal diameter of the needle (158) used in a particular application. For example, a needle of internal diameter 0.328 mm is appropriate for use with a 50 mL or 100 mL syringe. The needle (158) may be of any length and preferably, an open end of the needle (158) is beveled, however, needles with straight ends may also be used.

Any syringe suitable for handling the dispersible liquid may be used. The size of the syringe (152) is selected based on the flow rate of the test fluid or the desired pressure at which the test fluid is to eject. The syringe (152) is preferably a gas-tight syringe of the type typically used in injections. For example, gas-tight syringes having a capacity of 50 mL or 100 mL are suitable for use in the apparatus (100) and method (200) of the present invention. Gas-tight syringes are preferred because of their ability to contain liquid without evaporation or leakage. It would be appreciated that the term “syringe” as used herein refers to any standard syringe having a barrel, also referred to herein as the “body” or “housing” of the syringe, a plunger which is matched to the barrel, a tip, and a hollow needle of the type typically used for injections. The needle is attached to the tip of the syringe. Preferably, the body of the syringe is glass, however, syringes made of other materials such as plastic or metal may also be used.

The pre-selected pressure at which the test fluid is impacted onto the test specimen ranges from about 10 mmHg to about 250 mm Hg. Preferably, the pre-selected pressure at which the test fluid is impacted onto the test specimen ranges from 50 mmHg to 200 mm Hg.

The pre-selected amount of the test fluid ranges from about 0.1 mL to about 10 mL. Preferably, the pre-selected amount of the test fluid ranges from 0.5 mL to 8 mL. More preferably, the pre-selected amount of the test fluid ranges between 1.0 mL to 5 mL.

The pre-defined distance of tip of the needle (158) ejecting the stream of the test fluid towards the test specimen ranges from 100 mm to 400 mm.

The apparatus (100) may also include a penetration detector for quantitative determination of the extent of penetration of the testing fluid on the targeted area of the test specimen. The penetration detector may include any of chemical detectors, radioactive detectors, and the likes to determine the extent of penetration of the test specimen using standard laboratory procedures. To facilitate determination of the extent of penetration, the test fluid may also be colored with a suitable dye or colorant.

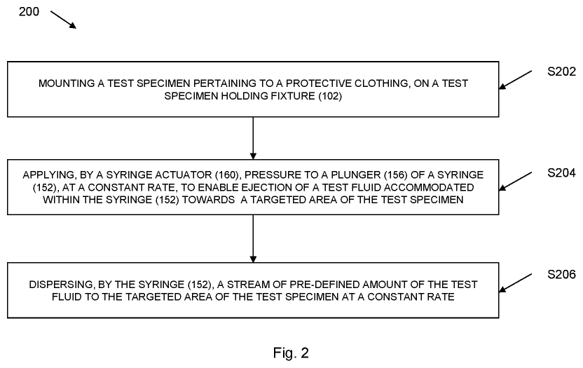

FIG. 2 illustrates a block diagram of a method (200) for penetration testing of the test specimen against the test fluid. The method (200) includes, at step (S202), mounting the test specimen on the test specimen holding fixture (102). At step (S204), pressure is applying to the plunger (156) of the syringe (152) by the syringe actuator (160), at a constant rate, to allow ejection of the test fluid accommodated within the body (154) of the syringe (152) towards the targeted area of the test specimen. Thereafter, the method includes, at step (S206), dispersing, by the syringe (152), a stream of pre-defined amount of the test fluid to the targeted area of the test specimen at a constant rate.

According to an embodiment of the present invention, the method may also include a step (S208) of allowing the stream of pre-defined amount of the test fluid to impact the targeted area of the test specimen at a pre-defined pressure.

In the step (S204) of applying pressure to the plunger (156) of the syringe (152), the stream of the test fluid is delivered from the syringe (152) to the test specimen, through the needle (158), at a constant rate. Any suitable means of applying pressure to the syringe (152) may be used. However, it is preferred that a device specifically designed to apply pressure to the plunger (156) is used. It is preferred that a syringe actuator (160) is used that has the ability to push the plunger (156) of the syringe (152) such that the plunger (156) moves continuously at a constant desired rate or speed, thereby dispensing the stream of the test fluid from the syringe (152) at a constant rate. Any device that can push the plunger (156) of the syringe at a constant rate may be used. Preferably, a syringe actuator, such as a commercially available syringe pump, for example, a Kd Scientific Syringe Pump, Model KDS 100, is used to dispense fluid from the syringe (152) at a constant rate. In addition, syringe pumps such as those commercially available from Cole-Parmer or Sigma-Aldrich are also suitable for use.

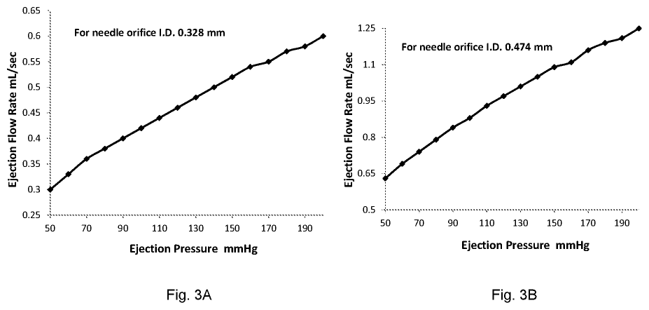

In an implementation, to measure resistance of an N95 surgical facemask against synthetic blood, the test specimen of N95 surgical mask is mounted on the convex backing (108) fixed to the outer door (110) which is held closed by the magnetic strips (114) along the front wall (106). The test fluid of the synthetic blood, having a pH value of 7.0±0.5 and a surface tension 0.042±0.002, is filled in a 50 mL capacity gas tight body (154) of a glass syringe having an internal diameter of approximately 27.5 mm attached to a needle (158) with an orifice bevel tip of orifice size 0.328 mm. For applying constant pressure to the plunger (156) of the syringe (152), a syringe infusion pump may be used as the syringe actuator (160). To measure protecting capability of the test specimen against a stream containing 2 mL of the synthetic blood at a pressure of 160 mmHg, corresponding flow rate of the synthetic blood is adjusted to 0.54 mL/sec (as per correlation graph shown in FIG. 3A). The distance of the test specimen to the tip of the needle (158) may be adjusted to 305 mm and a centerline of the needle (158) may be aligned to the center of the targeted area of the test specimen. The stream of synthetic blood is ejected to the targeted area of the test specimen and penetration of the synthetic blood is visually checked, after 10 seconds on the inner surface of the test specimen through the cut-out of the convex backing (108) fixed to the outer door (110). In case the penetration of the synthetic blood is not clearly visible, a tissue paper may be used to find any permeated synthetic blood to the inner surface of the test specimen. Appearance of the test fluid on the inner surface of the test material on the convex backing (108) constitutes a failure of the test material to a specific pressure. Such pressure may be measured in pounds per square inch, kg/cm², kPa, mmHg etc. The applied flowrate, on the syringe (152) is then determined by referring the correlation graphs in FIGS. 3A and 3B or other correlation graphs may be plotted according to orifice size of the needle (158) attached to the syringe (152). Therefore, by increasing or decreasing the flow rate and the internal diameter of the needle (158), applied pressure of the test fluid on the targeted area of the test specimen can be increased or decreased.

The apparatus (100) and the method (200) of the invention are suitable for evaluation of protective clothing materials, such as textile materials for medical use, especially medical facemask, against stream of test fluids, including body fluids such as pathogen containing liquids, blood, urine to name a few. The apparatus (100) and the method (200) are appropriate for measuring protective nature of any textile material against any liquid that may be dispersed in the form of a stream or splatter.

The apparatus and method of the present invention enable the user to determine the resistance of the protective clothing materials, such as textile materials for medical use, especially medical facemask, against test fluids, such as blood, bodily fluids, pathogens containing fluid or other liquid, quickly and conveniently. When necessary the syringe (152) may be easily disconnected from the needle (158), removed from the apparatus (100), refilled with other liquid and reconnected, or replaced with a new syringe, with only minimal disturbance to the apparatus (100). Similarly, the syringe (152) may be disconnected and replaced with another syringe having a larger or smaller volume, thereby permitting pressure or speed of ejection of the test fluid to be varied easily, reliably and quickly. By selecting appropriate size of the syringe (152), rate of compression of the syringe (152), and flow rate of stream of the test fluid, a wide range of pressures or amount of the streams can be achieved for measuring the extent of penetration of the test specimen, without the use of complicated equipment.

FIGS. 3A and 3B illustrate representations of correlation graphs for determination of flow rate of the stream of the test fluid at desired ejecting pressure for orifice sizes 0.328 mm and 0.474 mm of the needle (158), respectively. Speed, with which the syringe (152) is compressed, and size, i.e., internal diameter, of the syringe (152) control the rate or pressure of ejection of the stream of the test fluid. The resulting pressure at which the stream is impacted onto the test specimen may be easily converted to the flow rate of the stream according to the correlation graphs shown in FIGS. 3A and 3B for specific orifice sizes of the nozzle (11). Thus, the pressure and amount of the stream of the test fluid required for measuring resistance of the test specimen may be varied, immediately and conveniently. Accuracy of the pressure at which the test fluid impacts the test specimen depends only on accuracy of volumetric calibration of the syringe (152), calibration of internal diameter of the needle (158) attached to the syringe (152), and consistency of the speed at which the plunger (156) of the syringe (152) is moved by the syringe actuator (160).

Moreover, the pressure of the test fluid ejected from the tip of the needle (158) may be varied, easily and quickly, by varying the flow rate of the test fluid or speed at which the plunger (156) of the syringe (152) is compressed. Thus, the apparatus (100) and the method (200) prevent requirement of expensive equipment, such as compressed airline and separate reservoir of the test fluid.

According to an embodiment of the present invention, pressure of ejection of the stream of the test fluid is converted to flow rate. As flow rate is derived from velocity of the stream and time of delivery of the same, values of these terms are calculated on the basis of Bernoulli's equation which describes conditions of a flowing fluid at two or more points along a flow line:

$$\frac{{P}_{1}}{{δ}_{1}} + \frac{{v}_{1}^{2}}{2 g} + {z}_{1} = \frac{{P}_{2}}{{δ}_{2}} + \frac{{v}_{2}^{2}}{2 g} + {z}_{2} + {h}_{L}$$

where P₁ and P₂ are the pressures of the two fluid streams, v₁ and v₂ are the stream velocities, z₁ and z₂ their respective height above a defined plane, δ₁ and δ₂ are densities of two fluids respectively, g is the gravitational constant and h_{L} is heat loss.

In defining threat of the test fluid, such as, bodily fluid, pathogen or blood splatter, several assumptions were made and incorporated into the Bernoulli equation. In case the test fluid is blood, the flow of the test fluid through a blood vessel is assumed to be slow compared to flow of the test fluid through a puncture hole. Then, the term v₁ may be neglected and taken as zero. Likewise, since height of a blood vessel (syringe) and exiting stream are the same, terms pertaining to height (z₁ and z₂) may be neglected. The heat loss term can also be neglected because there is very little opportunity for frictional losses between inside and outside of the blood vessel.

The pressure in a free stream of fluid is zero. This fact taken together with the above assumptions, Bernoulli equation reduces to the following:

$$\frac{{P}_{1}}{{δ}_{1}} + \frac{{v}_{2}^{2}}{2 g}$$

The following equation can then be solved for velocity.

$${v}_{2} = \sqrt{\frac{2 g}{{δ}_{1}}} \cdot \sqrt{{P}_{1}}$$

Time of delivery (t) may be determined using the velocity calculated above, and volume of fluid (V) which passes through orifice size (d) of the needle (158) using the following equation:

$$t = \frac{4 V}{π {d}^{2} v}$$

The flow rate of the stream of test fluid is calculated by dividing the volume of the test fluid (V) by the delivery time (t) calculated above.

The apparatus (100) and the method (200) of the present invention provide the user with flexibility to the test specimen with a wide range of ejection pressures and amount of the test fluid, without the use of complicated equipment. The apparatus (100) and method (200) are suitable for ejection of the test fluid at pressure ranging, for example, from about 10 mmHg to about 250 mm Hg with 0.1 mL to 10 mL of fluid, preferably, from about 50 mmHg to about 200 mmHg with 1 mL to 5 mL of fluid. The apparatus (100) and method (200) are particularly suited for ejecting fluid stream with pressure in range of about 60 mm Hg to about 2000 mm Hg with the needle of 0.328 mm internal diameter.

The present invention provides qualitative analysis of the test specimen used for selecting materials which can withstand penetration of specific test fluids and challenge substances such as blood, blood-borne pathogens, bodily fluids, at the greatest pressure, and as a product quality assurance tool. One of the many uses for such qualitative analysis is in the design of protective clothing, such as gloves, arm shields, aprons, gowns, suits, hats, boots, facemasks and similar items which can limit human exposure to hazardous and biological liquids.

The present invention also provides for qualitative analysis of using a test fluid containing a pathogen which may penetrate the test specimen without visible evidence. Confirmation of pathogen penetration can then be determined using standard laboratory procedures.

The apparatus and the method of the present invention are useful for measuring and comparing the resistance of protective clothing materials by penetration testing against stream of pre-selected amount of test fluid at targeted pressure, and are especially useful where quick and reliable changes of pressure or volume of the stream to be ejected to the target specimen is desired. Thus, the present portable apparatus and method are useful in penetration testing of protective clothing materials, such as textile materials for medical use.

In view of the present disclosure which describes the present invention, all changes, modifications and variations within the meaning and range of equivalency are considered within the scope and spirit of the invention. It is to be understood that the aspects and embodiment of the disclosure described above may be used in any combination with each other. Several of the aspects and embodiment may be combined together to form a further embodiment of the disclosure.

1. An apparatus for penetration testing of a test specimen against a test fluid, comprising:
a test specimen holding fixture to support the test specimen; and
a fluid dispersing device for dispersing a stream of pre-defined amount of the test fluid at a predefined rate, to a targeted area of the test specimen,
wherein the fluid dispersing device comprises:
a syringe having a plunger and a needle; and
a syringe actuator for applying pressure to the plunger to enable ejection of the test fluid accommodated within the syringe through the needle to the targeted area of the test specimen.

2. The apparatus as claimed in claim 1, wherein the test specimen holding fixture 1-is mounted at a pre-defined distance from the fluid dispersing device.

3. The apparatus as claimed in claim 1, wherein the syringe actuator applies pressure to the plunger at a constant rate.

4. The apparatus as claimed in claim 1, wherein the stream of pre-defined amount of the test fluid impacts the targeted area of the test specimen at a pre-defined pressure ranging from 10 mmHg to 250 mm Hg.

5. The apparatus as claimed in claim 1, further comprising a penetration detector for quantitative determination of extent of penetration of the testing fluid on the targeted area of the test specimen.

6. The apparatus as claimed in claim 1, wherein the test specimen holding fixture comprises a front wall and an outer door, the front wall having a cut-out in which a convex backing is configured to mount the test specimen.

7. The apparatus as claimed in claim 6, wherein the convex backing is positioned between the front wall and the outer door.

8. The apparatus as claimed in claim 6, wherein the convex backing comprises a slot to enable a user to visually determine the extent of penetration of the testing fluid on the targeted area of the test specimen.

9. The apparatus as claimed in claim 1, wherein the pre-defined amount of the test fluid ranges from 0.1 mL to 10 mL.

10. A method for penetration testing of a test specimen against a test fluid, comprising the steps of:
mounting the test specimen on a test specimen holding fixture;
applying, by a syringe actuator, pressure to a plunger of a syringe, at a constant rate, to enable ejection of the test fluid accommodated within the syringe towards a targeted area of the test specimen; and
dispersing, by the syringe, a stream of pre-defined amount of the test fluid to the targeted area of the test specimen at a constant rate.

11. The method as claimed in claim 10, further comprising a step of allowing the stream of pre-defined amount of the test fluid to impact the targeted area of the test specimen at a pre-defined pressure ranging from 10 mmHg to 250 mm Hg.
